(19) United States
(12) Patent Application Publication
(10) Pub. No.: US 2010/0296045 A1
(43) Pub. Date: Nov. 25, 2010

(54) DIGITAL MEMORY DEVICE IMBEDDED IN THE TEMPLE PIECES OF EYEWEAR

(75) Inventors: Giancarla Agnoli, Treviso (IT); Alberto Da Re, Belluno (IT); Alessandro Callegari, Treviso (IT)

Correspondence Address: FROMMER LAWRENCE & HAUG, 745 FIFTH AVENUE- 10TH FL., NEW YORK, NY, 10151, US

(73) Assignee: Marchon Eyeware, Inc., Melville, NY (US)

(21) Appl. No.: 12/680,402

(22) PCT Filed: Oct. 1, 2008
(86) PCT No.: PCT/US08/78441

§ 371 Date: Aug. 6, 2010

Related U.S. Application Data
(60) Provisional application No. 60/997,125, filed on Oct. 1, 2007.

(51) Int. Cl. G02C 11/00; G06F 12/00; G02C 5/14

(52) U.S. Cl. 351/158; 711/101; 711/E12.001; 351/116

(57) ABSTRACT

An eyewear assembly having a frame and a separable temple piece in which a digital memory device is at least partially held within a temple piece.

### REFERENCE TO RELATED APPLICATIONS

This application claims priority to U.S. Provisional application Ser. No. 60/997,125, filed Oct. 1, 2007, the contents of which are incorporated herein by reference.

### FIELD OF THE INVENTION

The instant invention relates to a digital memory device. More particularly, the instant invention relates to a digital memory device within at least one temple piece of a set of eyewear.

### BACKGROUND OF THE INVENTION

Generally, USB memory devices are used as portable storage means for digital information, for example, for computer generated data, digital photographic images, digital movie files, or digital audio files. A standard USB memory device has a standardized male connector configured to achieve a secure connection with a computing device, such as a desktop or laptop computer, fitted with a female USB port. The most common connectors are the USB Series “A” plug (male) and receptacle (female).

USB memory devices are superior over prior digital storage media, such as 3.5 inch floppy discs, because the USB devices do not contain moving parts. The lack of moving parts increases the reliability of USB devices and reduces the size for the same memory capacity.

Typical USB devices are relatively small, approximately 0.5 inches [12.5 mm] in width, 0.1 inches [2.0 mm] in thickness, and 1.3 inches [34 mm] long with a capacity of several gigabytes. The large memory capacity in device of such a small size is a great convenience to the user. However, the small size also increases the likelihood of the device being misplaced.

Prior USB memory devices attempted to overcome the likelihood of loss by incorporating into the device a key ring, lanyard, or some other component substantial enough in size to make it less likely for the user to misplace the device, and if misplaced, to assist in visually locating the device. However, a component large enough to prevent misplacing the device defeated the very desirable characteristic of small size of the memory device.

Accordingly, a need exists for a USB memory device which takes advantage of the inherent small size but is not easily misplaced. The instant invention is directed to overcoming the problems and shortcomings associated with the loss-preventing methods employed in prior USB memory devices by incorporating a USB memory device into a structure having use critical to an activity regularly engaged in by the user. In doing so, the memory device assumes a secondary function, the absence of which would be immediately noted by the user. Thus, the desirable characteristic of small size of a USB memory device can be maintained while also providing a desirable loss-preventing feature.

In addition, in the last few years, there have been certain electronic devices that have been integrated into eyewear. For example, there is a sunglass frame that is available that includes an integrated digital music player. There are also specialized frames that can display movies and television shows directly onto the frame worn by a user so that, due to the close proximity of the frame to the user's eyes, the frame gives the user a “virtual” big screen viewing experience without the need for an actual big screen. Users typically need to connect cables from these frames to their computers or digital media players in order to view/hear the digital media. Therefore, an additional need exists to provide users with an easy means to access these digital media files on the next generation of eyewear products.

### SUMMARY OF THE INVENTION

It is therefore a principal objective of the instant invention to provide a USB memory device that has a secondary use which is critical to an activity frequently engaged in by the user such that absence of the device would be immediately noted by the user.

It is a further objective of the instant invention to provide a USB memory device incorporated into a separable temple piece of a set of eyewear.

It is a further objective of the instant invention to incorporate a USB memory device in a temple piece of a set of eyewear such that the portion of the temple piece incorporating the USB memory device can be separated from the remaining eyewear structure.

These and other objects and advantages are provided by the instant invention. In this regard, the instant invention is directed to a set of eyewear comprising at least one temple piece, at least a portion of which is separable from the remaining eyewear structure. The separable portion comprises a USB memory device. When separated from the remaining eyewear structure, a standard male USB Series “A” connector is exposed. The male USB connector thus exposed is capable of providing electrical connectivity when introduced into a standard USB port, or receptacle, for example, on a personal computer.

The USB memory device is capable of storing and exchanging digital data typically generated by a computing device, digital image source, or digital audio source. The data is available for ready exchange with a suitable device configured with a USB port. Following the data exchange, the USB memory device can be removed from the computing device in accordance with proper protocol. The exposed male connector of the USB memory device, incorporated in the separable portion of the temple piece, can be reinserted into the remaining eyewear structure. In doing so, the set of eyewear is made complete and wearable.

### BRIEF DESCRIPTION OF THE DRAWINGS

The following detailed description, given by way of example and not intended to limit the present invention solely thereto, will best be appreciated in conjunction with the accompanying drawings, wherein like reference numerals denote like element parts, in which:

FIG. 1 is a front view of a pair of eyewear according to one embodiment of the invention.

FIG. 2 is a top view taken along line II-II of FIG. 1 of a pair of eyewear according to one embodiment of the invention.

FIG. 3 is a left side view of a pair of eyewear according to one embodiment of the present invention.

FIG. 4 is a left side view of a temple piece of a pair of eyewear with the temple piece separated according to one embodiment of the present invention.

FIG. 5 is a partial cross sectional view taken along discontinuous line V-V of FIG. 4 of a separable temple piece for eyewear according to one embodiment of the present invention.

### DETAILED DESCRIPTION OF THE INVENTION

The instant invention will now be described more fully hereinafter with references to the accompanying drawings in which embodiments of the claimed eyewear are shown. This invention may, however, be embodied in many different forms and should not be construed as limited to the illustrated embodiments set forth herein. Rather, these illustrated embodiments are provided so that this disclosure will be thorough and complete, and will fully convey the scope of the invention to those skilled in the art. In the following description, like reference characters designate like or corresponding parts throughout the figures.

The instant invention relates to eyewear comprising a digital data storage device or flash drive, particularly one employing a memory device having a USB connection. Eyewear is well known in the art. Digital memory devices use non-volatile memory, or flash memory, that can be erased and re-recorded, have been known in the computer arts since the late 1990s. The USB memory devices are convenient for the amount of data storage for their physical size, the durability and reliability of the device, and speed in storing and providing digital data. However, the small size of the USB devices contributes to the ease in misplacing the device. Accordingly, the presently disclosed eyewear comprises a USB memory device at least partially within a temple piece. In this way, the device is readily available and it is unlikely the device will be misplaced because the eyewear of which it is a component will not be wearable without the device. A user will be unlikely to leave the USB memory device behind when finished manipulating digital data.

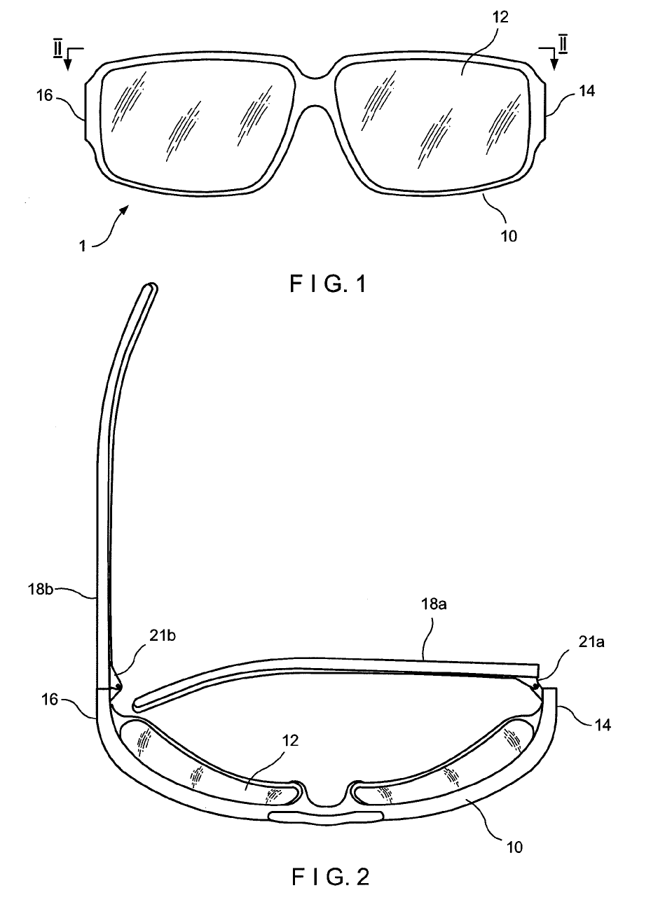

As illustrated in FIG. 1, the claimed eyewear 1 comprises a frame 10 adapted to support at least one lens 12. The frame 10 has a first end 14 a second end 16 spaced apart from the first end 14.

FIG. 2 is a top view of the pair of eyewear along line II-II as shown in FIG. 1. First and second temple pieces 18a and 18b (collectively 18) may have pivot ends 21a and 21b, respectively, adapted to pivotally engage with the first and second ends 14, 16 of the eyewear frame. The pivotal engagement allows the temple pieces 18 to assume at least a folded position and an unfolded, or extended, position. As illustrated, the first temple piece 18a is shown in the folded position as for storage. The second temple piece 18b is shown in the un-folded position, as if to be placed on the wearer's head.

In an alternate embodiment, the temple pieces 18, or portions thereof, may be integrally formed with the frame. Appropriately chosen materials for the integrally formed frame and temple pieces may provide sufficient resilience to allow desirable bending of the temple pieces in the area of the first and second ends 14, 16 of the frame 10. For example, the material chosen may have sufficient resiliency to allow the temple piece 18 to fold as illustrated by temple piece 18a in FIG. 2, as if for storage, against an applied holding force. The temple piece 18 may return to its wearable configuration, as illustrated in FIG. 2 by temple piece 18b, upon removal of the applied holding force. Alternately, the material may have characteristics allowing the temple pieces 18 to be placed in various positions without a holding force until the temple pieces are repositioned.

Eyewear 1 comprising a frame 10 and integrally formed temples 18 can provide the desired feature of positionable temple pieces 18 without a mechanical hinge joining the temple pieces 18 to the frame 10. Such a construction may be useful in certain applications, such as, for instance, maintaining electrical connectivity between the temple pieces a8 and the frame 10. Another anticipated embodiment include a hinge between frame ends 14, 16 and temple pieces 18

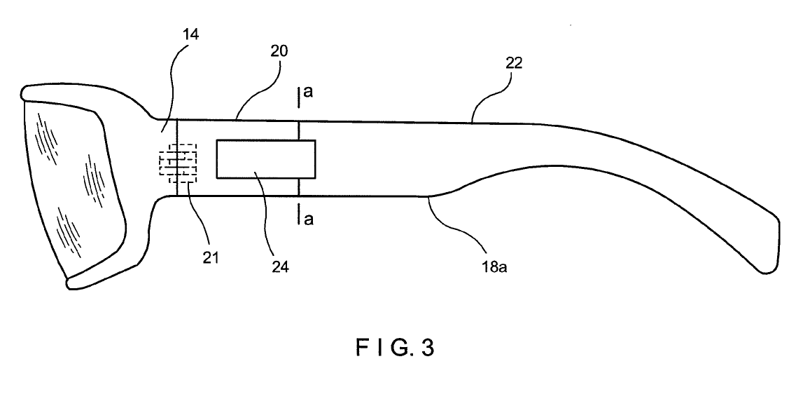

FIG. 3 is a left side view of a pair of exemplary eyewear according to one disclosed embodiment with first temple piece 18a unfolded, as if for wearing. According to one embodiment, first temple piece 18a is separable at a-a into mounted part 20 and removable part 22. According to one embodiment of the disclosed eyewear, first temple piece 18a may comprise a memory device 24, partially shown in FIG. 3, having a USB connector.

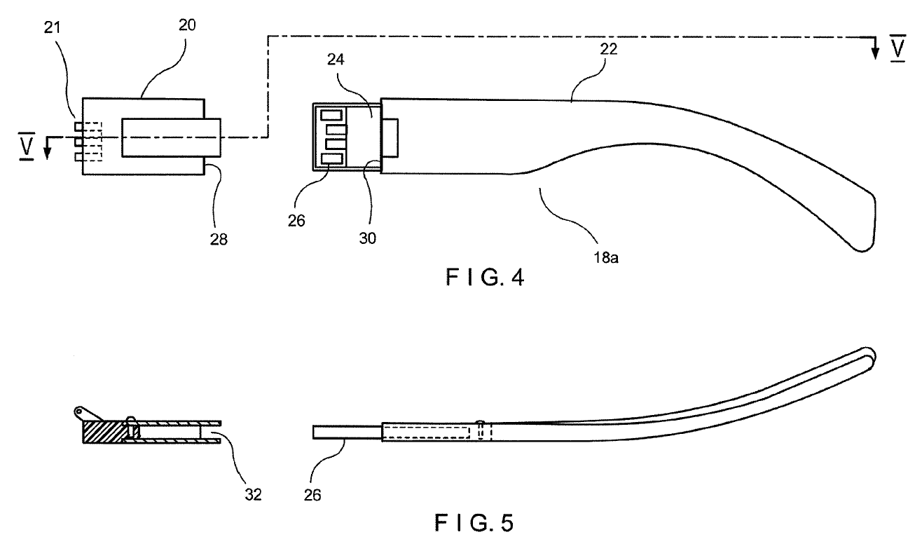

FIG. 4 is a left side view of an exemplary separable first temple piece 18a, separated at a-a of FIG. 3 into mounted part 20 and removable part 22. As shown, when the temple piece is separated at a-a, at least a part 26 of a USB Series “A” plug 24 is exposed, extending beyond second mating end 30 of removable part 22. The plug provides access to data stored in a digital memory device 24. The remaining portion of USB memory device 24 may be embedded in the removable part 22 of temple piece 18a.

Although the USB device 24 is shown in first temple piece 18a, one of ordinary skill in the art would recognize that the claimed eyewear may contain a USB memory device in either the first or second temple piece 18a, 18b.

Additionally, for convenience, the USB memory device 24 is shown in the removable part 22 of separable temple piece 18a. However, one of ordinary skill in the art will recognize that the USB memory device could be placed within the mounted part 20 and still be within the scope of the disclosed eyewear.

FIG. 5 is a partial cross sectional view of exemplary separable first temple piece 18a. The section extends through a horizontal plane (as shown) extending through mounted portion 20. Removable part 22 is not shown in section.

According to one claimed embodiment, first mating end 28 of mounted part 20 comprises a cavity 32 configured to securely releasably accept at least a portion of exposed part 26 of the USB memory device 24. As shown in FIG. 5, cavity 32 of mating end 28 of mounted part 20 is sized to accept the USB Series “A” plug between opposing wall surfaces of the cavity. The wall surfaces may include additional features (not shown) to increase the security of the USB plug 26 within the cavity as would be apparent to one of ordinary skill in the art.

In addition to providing a secure attachment between first and second mating ends 28 and 30, placing USB plug 26 within cavity 32 protects the plug from inadvertent contact and potential damage. In one embodiment, USB plug 26 is fully accepted within cavity 32 and first and second mating ends 28 and 30 come into contact, or nearly come into contact, with each other. Such an arrangement may provide the greatest amount of protection for the plug 26 as well as provide the greatest engagement between plug 26 and cavity 32, resulting in a more secure fit. Additionally, abutting mating ends may provide a superior aesthetic appearance for the temple piece 18 and eyewear 1.

In order to utilize the USB memory device 24, the user would separate the separable temple piece 18a at the interface a-a between first and second mating ends 28 and 30. When plug 26 becomes fully disengaged from cavity 32, the USB plug 26 is capable of engaging a target electronic device, such as a personal computer, to provide a digital data communication pathway between the USB storage device 24 and the target electronic device using appropriate architecture.

For returning the eyewear 1 to a condition for wearing, the USB device 24 is prepared for removal according to the appropriate protocol. USB plug 26 may then be disengaged from the target electronic device. Once the USB plug 26 is fully disengaged from the target device, the plug 26 may then be inserted into the cavity 32 provided at the mating end 28 of mounted part 20. Application of sufficient axial force between the mounted and removable parts 20 and 22 will fully engage the USB plug 26 securely within the cavity 32. In an exemplary embodiment, first and second mating ends 28 and 30 will abut forming a secure attachment between mounted and removable parts 20 and 22 of separable temple piece 18a, as well as the appearance of a unitary temple piece.

One of ordinary skill in the art will recognize that it is also possible to have a frame 10 that has electronic capabilities integrated into the frame 10. For example, the frame 10 may include an integrated music player for listening to digital music files or a heads-up display projector for viewing digital movies or photographs. In another embodiment of the present invention, the cavity 32 in frame 10 may comprise a USB Series “A” receptacle that provides a communications pathway between the USB device 24 in the temple 18 to the integrated electronics in frame 10. So, for example, if frame 10 has electronics for viewing digital movies, then the digital movies may be moved from a computing device onto USB memory device 24 as described above, but rather than just being used to transport these movies to another computing device, when the temple 18 is reconnected to the eyewear 1, then a user may be able to access these files and view movies using the eyewear 1.

In the foregoing embodiment, there could be potential complications with having a pivotal arrangement interposed between the USB device 24 provided on temple 18 and the frame 10 due to for example the complexity of providing an uninterrupted communications pathway between the USB device 24 and the electronics integrated on frame 10. It may therefore be desirable to have a temple 18 that does not have a pivotal arrangement. Such a temple piece could be a one-piece temple 18 comprising a USB device 24 that connects directly into frame 10. Alternately, the temple pieces 18 could be separable such that a first portion of a first temple is formed with the frame 10 and removably receives a second portion of the temple.

One or ordinary skill in the art will understand that it may also be possible to have the electronics integrated directly onto the temple 18 so that, for example, the temple 18 could be provided with electronics for playing digital music files embedded in the temple 18, and a direct communications pathway is provided between the USB device 24 and the embedded music playing electronics. Even in such a case, it may be necessary to provide a communications pathway between the temple 18 and the frame 10. For example, it would be necessary to provide data signals to the other temple on the eyewear 1 in order to play the digital music in stereo.

Further, although the preferred embodiments of the present invention have included a USB device, one of ordinary skill in the art should recognize that the USB interface could be replaced by another data interface standard without departing from the spirit and scope of the invention as defined by the appended claims.

Although a preferred embodiment of the present invention and modifications thereof have been described in detail herein, it is to be understood that this invention is not limited to this precise embodiment and modifications, and that other modifications and variations may be effected by one skilled in the art without departing from the spirit and scope of the invention as defined by the appended claims.

What is claimed is:

1. An eyewear assembly comprising:
a frame having a first end and a second end spaced from the first end; and
a first temple piece comprising:
a first temporal end adjacent to the frame first end; and
a first support end adapted to engage a portion of a wearer's head;
wherein the first temple piece comprises a memory storage device connected to a data exchange terminal.

2. The eyewear assembly of claim 1 wherein the first temporal end is pivotally attached to the frame.

3. The eyewear assembly of claim 1 wherein the memory device is a universal serial bus memory device.

4. An eyewear assembly comprising:
a frame having a first end and a second end spaced from the first end; and
a first separable temple piece comprising:
a mounted part comprising:
a first temporal end adjacent to the frame first end; and
a first mating end spaced apart from the first temporal end;
a first removable part having a second mating end adapted to engage the first mating end and a support end adapted to engage a portion of a wearer's head; and
a memory device at least partially within the mounted part or the removable part of the separable temple piece, the memory device connected to a data exchange terminal.

5. The eyewear assembly of claim 4 wherein the first temporal end is pivotally attached to the frame.

6. The eyewear assembly of claim 4 wherein the memory device is a universal serial bus memory device.

7. An eyewear assembly comprising:
a frame having a first end and a second end spaced from the first end; and
a separable temple piece comprising:
a mounted part comprising:
a first temporal end adjacent to the frame first end; and
a first mating end spaced apart from the first temporal end;
a first removable part having a second mating end adapted to engage the first mating end and a removable support end adapted to engage a portion of a wearer's head; and
a memory device connected to a data exchange terminal,
wherein the first removable part comprises the memory device.

8. The eyewear assembly of claim 7 wherein the separable temple piece further comprises:
a first cavity in the mounted part, the cavity extending from the first mating end towards the first temporal end; and
at least one projection extending from the second mating end, the first cavity adapted to accept the at least one projection.

9. The eyewear assembly of claim 8 wherein the projection is a data exchange terminal connected to the memory device.

10. The eyewear assembly of claim 9 wherein the data exchange terminal is a universal serial bus plug.

11. An eyewear assembly comprising:
a frame having a first end and a second end spaced from the first end; and
a separable temple piece comprising:
a mounted part comprising:
a first temporal end adjacent to the frame first end; and
a first mating end spaced apart from the first temporal end;
a first removable part comprising:
a second mating end;
a third mating end; and
a second removable part comprising:
a fourth mating end, wherein
one of the first and second mating ends is a cavity and one of the first and second mating ends is a projection, and
one of the third and fourth mating ends is a cavity and one of the third and fourth mating ends is a projection;
wherein at least one of the projections comprises at least part of a data exchange terminal attached to a memory device and at least one of the cavities is adapted to removably engage the projection.

12. The eyewear assembly of claim 11 wherein the data exchange terminal is a universal serial bus plug.
